(19) United States
(12) Patent Application Publication
(10) Pub. No.: US 2022/0179954 A1
(43) Pub. Date: Jun. 9, 2022

(54) METHOD FOR GENERATING CHARACTERISTIC INFORMATION OF MALWARE WHICH INFORMS ATTACK TYPE OF THE MALWARE

(71) Applicant: SANDS LAB Inc., Seoul (KR)

(72) Inventor: Kihong Kim, Seoul (KR)

(21) Appl. No.: 17/541,605

(22) Filed: Dec. 3, 2021

(30) Foreign Application Priority Data
Dec. 7, 2020 (KR) 10-2020-0169579

(51) Int. Cl. G06F 21/56

(52) U.S. Cl. CPC G06F 21/561; G06F 21/564; G06F 21/563

(57) ABSTRACT

The present disclosure provides a computer-implemented method for generating a characteristic information of a malware, which comprises receiving an EXE file of a computer program which is pre-coded for carrying out an attack of a specific malware, the attack corresponding to one of the pre-categorized attack type; generating a first OP Code data set from a first OP Code of attack type of the malware coded in the computer program, the first OP Code being acquired by disassembling the EXE file; acquiring a second OP Code by disassembling a received malware file; and generating a characteristic information of the received malware file based on the comparison result between the first OP Code data set and the second OP Code, the characteristic information relating to the attack type of the received malware file.

### CROSS-REFERENCE TO RELATED APPLICATION

This application claims priority to Korean Patent Application No. 10-2020-0169579 filed on Dec. 7, 2020. The application is expressly incorporated herein by reference.

### TECHNICAL FIELD

The present disclosure relates to a method for generating malware information. Specifically, the present disclosure relates to a method for generating characteristic information of malware, which informs the attack type of the malware by analyzing disassembled information of the malware.

### BACKGROUND

The IT technologies have radically changed the world for recent 30 years to cause the tremendous changes to human life. In particular, the mobile technologies and wireless communication have driven those changes. As the life infrastructure depends upon the IT based technologies, cyber-crimes attacking the IT infrastructure have also been on the rise.

Malware accounts for most of the cyber-crimes. By intrusion of malware, a software operates as intended by a third party to cause information theft, information destruction and manipulation of information, not its originally intended purpose.

In the past, the uniquely identifiable name was given to a malware according to the characteristic, the attributes, the name of the malware creator and the like. Recently, millions of malwares are created a day and the name of the malware is automatically given based on the category of the malware and OS.

The automatically given name of the malware shows limited information of the malware. Therefore, the user that looks at the name cannot understand the information about what kind of damage it causes, what kind of action it causes, and what kind of harm it does.

In order to know the detailed information, the user should make a rough guess by search based on the automatically given name. The user cannot find the detailed information of the malware if the search fails, or an anti-virus company does not provide the detailed information of the malware.

### SUMMARY

The object of the present disclosure is to provide a method for automatically generating the characteristic information of a malware so that the malicious attack caused by the malware can be easily recognized.

In order to accomplish the object, the present disclosure provides a computer-implemented method for generating a characteristic information of a malware, which comprises receiving an EXE file of a computer program which is pre-coded for carrying out an attack of a specific malware, the attack corresponding to one of the pre-categorized attack types; generating a first OP Code data set from a first OP Code of attack type of the malware coded in the computer program, the first OP Code being acquired by disassembling the EXE file; acquiring a second OP Code by disassembling a received malware file; and generating a characteristic information of the received malware file based on the comparison result between the first OP Code data set and the second OP Code, the characteristic information relating to the attack type of the received malware file.

The received malware file can be determined to be a malware of the attack type of the first OP Code data set if the similarity between the first OP Code data set and the second OP Code acquired from the received malware file is greater than or equal to a predetermined value.

The attack types of malwares can be categorized to be distinguished from one another.

The method of the present disclosure can further comprise carrying out a machine learning to the second OP Code based on the first OP Code data set.

The first OP Code data set can include the attack types which are categorized based on the attack type IDs of MITRE ATT&CK.

The present disclosure also provides the system performing the method of the present disclosure.

The present disclosure provides the computer program product performing the method of the present disclosure.

### BRIEF DESCRIPTION OF DRAWINGS

FIG. 1 is a drawing for explanation of the basic concept of the present disclosure;

FIG. 2 is a drawing showing the process that a specific function of an executable file (referred to as “EXE file” hereinafter) is disassembled for generating OP Code;

FIG. 3 is a flow chart of a method for generating a basic data set for generation of a malware information according to the present disclosure;

FIG. 4 is a flow chart of a method for generating the information of the received malware;

FIG. 5 is an exemplary data set of a first OP Code which is categorized based on attack type according to the present disclosure; and

FIG. 6 is an exemplary block diagram of electronic arithmetic device carrying out the present disclosure.

It should be understood that the above-referenced drawings are not necessarily to scale, presenting a somewhat simplified representation of various preferred features illustrative of the basic principles of the disclosure. The specific design features of the present disclosure will be determined in part by the particular intended application and use environment.

### DETAILED DESCRIPTION

Hereinafter, the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

In this specification, the order of each step should be understood in a non-limited manner unless a preceding step must be performed logically and temporally before a following step. That is, except for the exceptional cases as described above, although a process described as a following step is preceded by a process described as a preceding step, it does not affect the nature of the present disclosure, and the scope of rights should be defined regardless of the order of the steps. In addition, in this specification, “A or B” is defined not only as selectively referring to either A or B, but also as including both A and B. In addition, in this specification, the term “comprise” has a meaning of further including other components in addition to the components listed.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The term “module” or “unit” means a logical combination of a universal hardware and a software carrying out required function.

The terms “first,” “second,” or the like are herein used to distinguishably refer to same or similar elements, or the steps of the present disclosure and they may not infer an order or a plurality.

In this specification, the essential elements for the present disclosure will be described and the non-essential elements may not be described. However, the scope of the present disclosure should not be limited to the invention including only the described components. Further, it should be understood that the invention which includes additional element or does not have non-essential elements can be within the scope of the present disclosure.

The method of the present disclosure can be an electronic arithmetic device.

The electronic arithmetic device can be a device such as a computer, tablet, mobile phone, portable computing device, stationary computing device, server computer etc. Additionally, it is understood that one or more various methods, or aspects thereof, may be executed by at least one processor. The processor may be implemented on a computer, tablet, mobile device, portable computing device, etc. A memory configured to store program instructions may also be implemented in the device(s), in which case the processor is specifically programmed to execute the stored program instructions to perform one or more processes, which are described further below. Moreover, it is understood that the below information, methods, etc. may be executed by a computer, tablet, mobile device, portable computing device, etc. including the processor, in conjunction with one or more additional components, as described in detail below. Furthermore, control logic may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

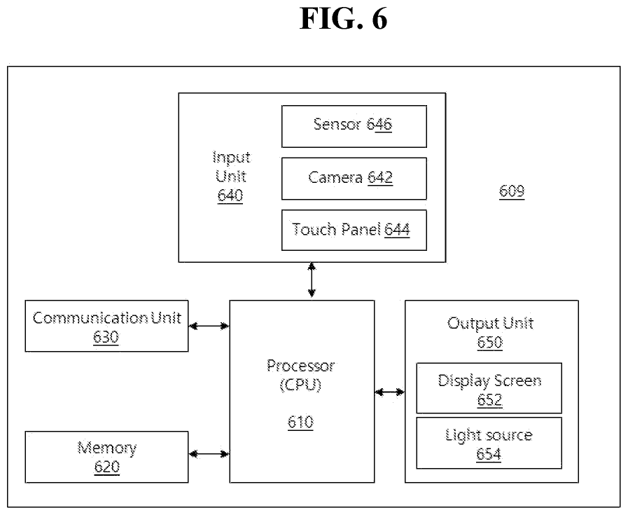

A variety of devices can be used herein. FIG. 6 illustrates an example diagrammatic view of an exemplary device architecture according to embodiments of the present disclosure. As shown in FIG. 6, a device (609) may contain multiple components, including, but not limited to, a processor (e.g., central processing unit (CPU); 610), a memory (620; also referred to as “computer-readable storage media), a wired or wireless communication unit (630), one or more input units (640), and one or more output units (650). It should be noted that the architecture depicted in FIG. 6 is simplified and provided merely for demonstration purposes. The architecture of the device (609) can be modified in any suitable manner as would be understood by a person having ordinary skill in the art, in accordance with the present claims. Moreover, the components of the device (609) themselves may be modified in any suitable manner as would be understood by a person having ordinary skill in the art, in accordance with the present claims. Therefore, the device architecture depicted in FIG. 6 should be treated as exemplary only and should not be treated as limiting the scope of the present disclosure.

The processor (610) is capable of controlling operation of the device (609). More specifically, the processor (610) may be operable to control and interact with multiple components installed in the device (609), as shown in FIG. 6. For instance, the memory (620) can store program instructions that are executable by the processor (610) and data. The process described herein may be stored in the form of program instructions in the memory (620) for execution by the processor (610). The communication unit (630) can allow the device (609) to transmit data to and receive data from one or more external devices via a communication network. The input unit (640) can enable the device (609) to receive input of various types, such as audio/visual input, user input, data input, and the like. To this end, the input unit (640) may be composed of multiple input devices for accepting input of various types, including, for instance, one or more cameras (642; i.e., an “image acquisition unit”), touch panel (644), microphone (not shown), sensors (646), keyboards, mice, one or more buttons or switches (not shown), and so forth. The term “image acquisition unit,” as used herein, may refer to the camera (642), but is not limited thereto. The input devices included in the input (640) may be manipulated by a user. The output unit (650) can display information on the display screen (652) for a user to view. The display screen (652) can also be configured to accept one or more inputs, such as a user tapping or pressing the screen (652), through a variety of mechanisms known in the art. The output unit (650) may further include a light source (654). The device (609) is illustrated as a single component, but the device may also be composed of multiple, separate components that are connected together and interact with each other during use.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

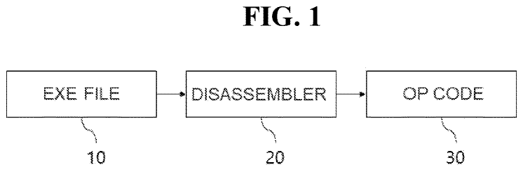

FIG. 1 is a drawing for explanation of the basic concept of the present disclosure.

Generally, an EXE file (10) has a PE structure (Portable Executable structure). OP Code can be generated by a disassembler (20) which receives the EXE file (10) and then disassembles the EXE file (10).

Generally, OP Code consists of an execution structure/execution flow of a computer, various instruction set and the like. The OS allows the computer program to operate as the developer intends by processing data according to the control and flow of the OP Code.

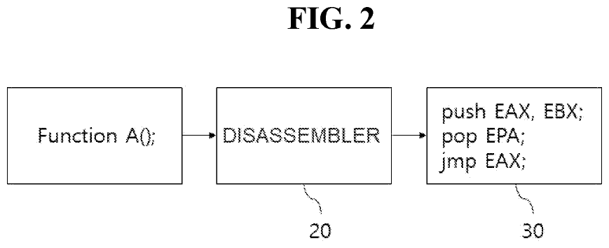

As illustrated in FIG. 2, a specific function “A” in an EXE file is disassembled by the disassembler (20) so that an OP Code is produced.

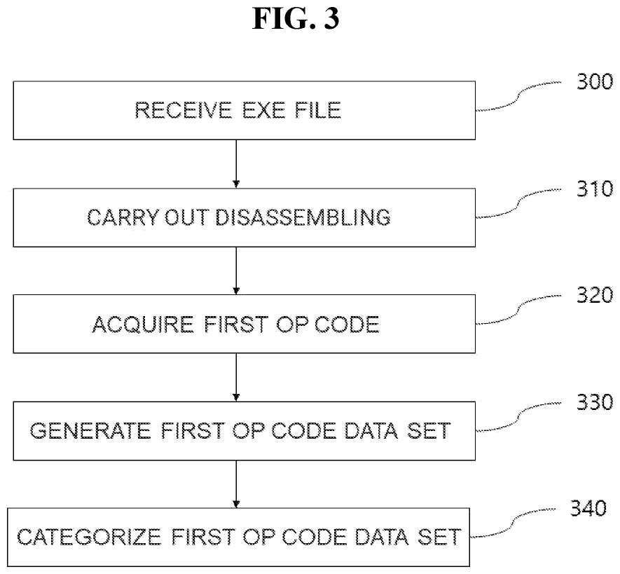

FIG. 3 is a flow chart of a method for generating basic data set for generation of malware information. As described in the above, the present disclosure can be carried out by an electronic arithmetic device.

In the step (300), an EXE file is received by an electronic arithmetic device such as a computer. The EXE file is an executable file of a computer program which is pre-coded for carrying out a known attack. For example, MITRE ATT&CK (https//attack.mitre.org) defines typical attack types which are carried out by hackers and malware; and manages them as CVE Codes (Common Vulnerabilities and Exposure Code). Each attack type has its unique ID, thereby enabling easy categorization.

The computer program is pre-coded to carry out the known attack types of malwares. The EXE file is generated by a compiler which compiles the computer program and then is received in the step (300).

The received EXE file (10) enters the disassembler (20) and is disassembled in the step (310), and then the first OP Code is acquired in the step (320). The first OP Code acts as a role of a basic information for generating the information of the malware as described in the below.

The first OP Codes are generated by disassembling the EXE files of computer programs which are pre-coded to carry out various attack types of malwares and are accumulated to make a data set (first OP Code data set). One first OP Code data set can consist of a plurality of the first OP Codes for a specific attack type.

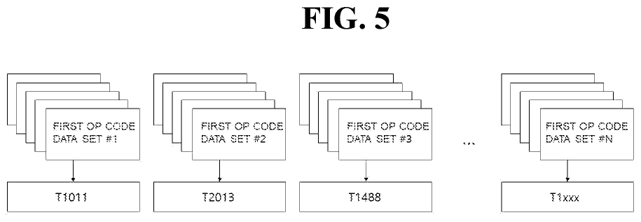

The first OP Code data set is categorized based on the attack type in the step (340). FIG. 5 shows the exemplary categorization of the first OP Code data set. In the example in FIG. 5, the first OP Code data set #1 is categorized as “T1011,” one of the attack type IDs of MITRE ATT&CK and the first OP Code data set #2 is categorized as “T2013,” one of the attack type IDs of MITRE ATT&CK.

A machine learning can be carried out for each attack type based on the categorized first OP Code data set, thereby generating learning data for the attack type.

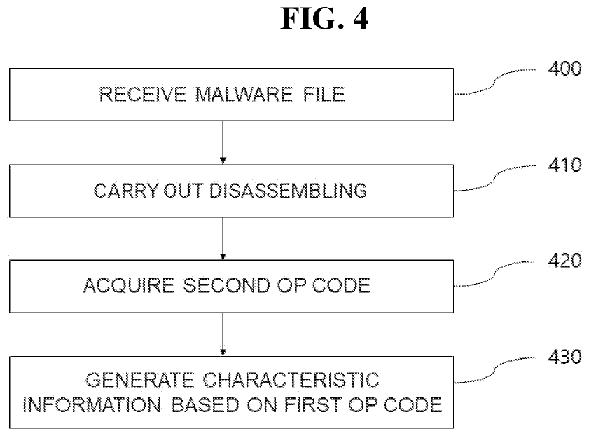

FIG. 4 is a flow chart of a method for generating the information of a received malware. The present disclosure relates to a method for generating the information of the detected malware, not to a method for detecting a malware. The details of the method for detecting a malware are not described because any method for the detection can be applied.

In the step (400), the file which is detected as a malware is received. The detected file of the malware is transmitted to the disassembler (20) in the step (410); the received file is disassembled by the disassembler (20); and then the OP Code (a second OP Code) of the received malware is acquired in the step (420). The second OP Code is compared with the first OP Code data set. If the similarity between the second OP Code and the first OP Code data set is greater than or equal to a predetermined value, the characteristic information which is associated with the first OP Code data set is set to be the characteristic information of the received malware.

The accuracy of the similarity determination can be improved by a machine learning to the received malware file based on the first OP Code data set. The OP Codes acquired from the various known malware can be used for a machine learning based on the first OP Code data set. According to the embodiments, high accuracy is guaranteed for generating a characteristic information of malware.

The machine learning can be Supervised Learning or Unsupervised Learning. The various algorithms of the machine learning can be applied for the present disclosure. The details of the algorithm of machine learning are not described because the present disclosure does not relate to the algorithm.

Table 1 shows the characteristic information of a malware file “malware.exe.” The information is generated by disassembling “malware.exe;” acquiring the second OP Code of the malware file; comparing the second OP Code with the first OP Code data set; and then determining the similarity therebetween. A plurality of the categories of the attack type of “malware.exe” are shown in Table 1.

TABLE 1

| | | | | Explanation of |
|---|---|---|---|---|
| File | OP Code | | T-ID | Attack Type |
| malware.exe | MOV DWORD PTR SS: [EBP-4], 1 | | 1022 | Change Important |
| | MOV DWORD PTR SS: [EBP-8], 2 | | | Registry of System |
| | MOV EDX, DWORD PTR SS: [EBP-8] | | | |
| | LEA EAX, DWORD PTR SS: [EBP-4] | | | |
| | PUSH EBP | | 1077 | Register Startup |
| | MOV EBP, ESP | | | Program |
| | SUB ESP, 18 | | | |
| | AND ESP, FFFFFFF0 | | | |
| | MOV EAX, 0 | | | |
| | LEA EAX, DWORD PTR SS: [EBP-4] | | 1034 | Disable Windows |
| | ADD DWORD PTR DS: [EAX], EDX | | | Firewall |
| | MOV EAX, 0 | | | |
| | LEAVE | | | |
| | PUSH EBP | | 1090 | Add New User |
| | MOV EBP, ESP | | | |
| | MOV EAX, DWORD PTR SS: [EBP+B] | | | |
| | ADD EAX, DWORD PTR SS: [EBP+C] | | | |
| | POP EBP | | | |
| | RETN | | | |
| | CMP DWORD PTR SS: [EBP-4], 2 | | 2011 | Make Backdoor |
| | JNZ SHORT if.00401035 | | | |
| | PUSH if.0040C008 | | | |
| | CALL if.printf | | | |
| | ADD ESP,4 | | | |
| | JMP SHORT if.00401042 | | | |
| | CMP DWORD PTR SS: [EBP-B],1 | | 3744 | Stop Security |
| | JE SHORT switch.00401027 | | | Program |
| | CMP DWORD PTR SS: [EBP-B],2 | | | |
| | JE SHORT switch.00401036 | | | |
| | CMP DWORD PTR SS: [EBP-B],3 | | | |
| | JE SHORT switch.00401045 | | | |
| | JMP SHORT switch.00401054 | | | |
| | CMP DWORD PTR SS: [EBP-4],0 | | 1001 | Reset Password |
| | JLE SHORT while.0040101C | | | |
| | MOV EAX,DWORD PTR SS: EBP-4] | | | |
| | SUB EAX,1 | | | |
| | MOV DWORD PTR SS: [EBP-4],EAX | | | |
| | JMP SHORT while.0040100B | | | |
| | 8BEC | MOV EBP, ESP | 1773 | Register Windows |
| | 8B45 10 | MOV EAX, DWORD PTR SS: | | Service |
| | 50 | [EBP+10] | | |
| | 8B4D 0C | PUSH EAX | | |
| | 51 | MOV ECX, DWORD PTR SS: | | |
| | 8B55 08 | [EBP+C] | | |
| | 52 | PUSH ECX | | |
| | 68 00C04000 | MOV EDX, DWORD PTR SS: | | |
| | E8 88000000 | [EBP+8] | | |
| | | PUSH EDX | | |
| | | PUSH all_call.0040C000 | | |
| | | CALL all_call.printf | | |

The T-IDs in Table are based on the IDs of the attack type defined in MITRE ATT&CK. If the similarity between a first OP Code data set and the second OP Code acquired from “malware.exe” is greater than or equal to a predetermined value, the attack type of the first OP Code data set is set to the characteristic information of “malware.exe.” The second OP Code acquired from the malware file can relate to a plurality of attack types. For example, the second OP Code can be compared with all of the first OP Code #1 to #N so that the similarities between the second OP Code and all of the first OP Codes are determined.

According to the present disclosure, the characteristic information of malware can be easily determined by disassembling process of the malware file and similarity comparison with the first OP Code data set.

Although the present disclosure has been described with reference to accompanying drawings, the scope of the present disclosure is determined by the claims described below and should not be interpreted as being restricted by the embodiments and/or drawings described above. It should be clearly understood that improvements, changes and modifications of the present disclosure disclosed in the claims and apparent to those skilled in the art also fall within the scope of the present disclosure. Accordingly, this description is to be taken only by way of example and not to otherwise limit the scope of the embodiments herein.

1. A computer-implemented method for generating a characteristic information of a malware, the method comprising:
receiving an EXE file of a computer program which is pre-coded for carrying out an attack of a specific malware, the attack corresponding to one of the pre-categorized attack types;
generating a first OP Code data set from a first OP Code of attack type of the malware coded in the computer program, the first OP Code being acquired by disassembling the EXE file;
acquiring a second OP Code by disassembling a received malware file; and
generating a characteristic information of the received malware file based on the comparison result between the first OP Code data set and the second OP Code, the characteristic information relating to the attack type of the received malware file.

2. The method according to claim 1, wherein the received malware file is determined to be a malware of the attack type of the first OP Code data set if the similarity between the first OP Code data set and the second OP Code acquired from the received malware file is greater than or equal to a predetermined value.

3. The method according to claim 1, wherein the attack types of malwares are categorized to be distinguished from one another.

4. The method according to claim 3, further comprising carrying out a machine learning to the second OP Code based on the first OP Code data set.

5. The method according to claim 3, wherein the first OP Code data set has the attack types which are categorized based on the attack type IDs of MITRE ATT&CK.

6. A computer-implemented system comprising one or more processors and one or more computer-readable media storing computer-executable instructions that, when executed, cause the one or more processors to perform a method comprising:
receiving an EXE file of a computer program which is pre-coded for carrying out an attack of a specific malware, the attack corresponding to one of the pre-categorized attack types;
generating a first OP Code data set from a first OP Code of attack type of the malware coded in the computer program, the first OP Code being acquired by disassembling the EXE file;
acquiring a second OP Code by disassembling a received malware file; and
generating a characteristic information of the received malware file based on the comparison result between the first OP Code data set and the second OP Code, the characteristic information relating to the attack type of the received malware file.

7. A computer program product comprising one or more computer-readable storage media and program instructions stored in at least one of the one or more storage media, the program instructions executable by a processor to cause the processor to perform a method comprising:
receiving an EXE file of a computer program which is pre-coded for carrying out an attack of a specific malware, the attack corresponding to one of the pre-categorized attack types;
generating a first OP Code data set from a first OP Code of attack type of the malware coded in the computer program, the first OP Code being acquired by disassembling the EXE file;
acquiring a second OP Code by disassembling a received malware file; and
generating a characteristic information of the received malware file based on the comparison result between the first OP Code data set and the second OP Code, the characteristic information relating to the attack type of the received malware file.
